(19) United States
(12) Patent Application Publication
(10) Pub. No.: US 2017/0280140 A1
(43) Pub. Date: Sep. 28, 2017

(54) METHOD AND APPARATUS FOR ADAPTIVELY ENCODING, DECODING A VIDEO SIGNAL BASED ON SEPARABLE TRANSFORM

(71) Applicant: LG ELECTRONICS INC., Seoul (KR)

(72) Inventors: Amir SAID, San Jose, CA (US); Hilmi Enes EGILMEZ, San Jose, CA (US); Yung-Hsuan CHAO, San Jose, CA (US)

(21) Appl. No.: 15/512,428

(22) PCT Filed: Jul. 14, 2015
(86) PCT No.: PCT/KR2015/007312

§ 371 Date: Mar. 17, 2017

Related U.S. Application Data
(60) Provisional application No. 62/052,469, filed on Sep. 19, 2014.

(51) Int. Cl. H04N 19/134; H04N 19/176; H04N 19/60; H04N 19/124; H04N 19/122

(52) U.S. Cl. CPC H04N 19/134; H04N 19/124; H04N 19/122; H04N 19/649; H04N 19/176

(57) ABSTRACT

Disclosed herein is a method of performing an adaptive video coding, comprising: determining transform subsets including a group index and linear transforms with dimensions M×M and N×N, wherein the linear transforms correspond to at least one of a null transform and predefined transforms; selecting an optimal transform subset for a transform unit from the determined transform subsets, wherein each of rows and columns of the transform unit corresponds to different linear transform; and encoding the optimal transform subset.

### CROSS-REFERENCE TO RELATED APPLICATIONS

This application is the National Stage filing under 35 U.S.C. 371 of International Application No. PCT/KR2015/007312, filed on Jul. 14, 2015, which claims the benefit of U.S. Provisional Application No. 62/052,469, filed on Sep. 19, 2014, the contents of which are all hereby incorporated by reference herein in their entirety.

### TECHNICAL FIELD

The present invention relates to a method and apparatus for processing a video signal and, more particularly, to adaptively encoding and decoding a video signal based on a separable transform.

### BACKGROUND ART

Compression coding means a series of signal processing technologies for sending digitalized information through a communication line or storing digitalized information in a form suitable for a storage medium. Media, such as video, an image, and voice, may be the subject of compression coding. In particular, a technology for performing compression coding on video is called video compression.

The next-generation video content expects to feature high spatial resolution, a high frame rate, and high dimensionality of a video scene representation. The processing of such content would require a significant increase in memory storage, a memory access rate, and processing power.

Accordingly, it is necessary to provide more efficient video compression method by adapting linear transforms to the signal's statistics in different parts of the video sequence.

### DISCLOSURE

### Technical Problem

In the most general form of adaptation, a video block of N×N pixels is transformed with an N²×N² matrix, requiring N⁴ operations. When using a separable transformation, each vertical and horizontal N-pixel line of the video block can be transformed using an N×N matrix, with a smaller complexity of 2N³ operations, and some fast transforms can be computed with 2N² log₂N operations. However, to obtain the highest level of adaptation with this computational complexity we need to allow up to 2N different line transformations.

### Technical Solution

This invention provides methods to make this approach practical by reducing the bit-rate overhead to encode transform matrix data, and encode which transforms to be used in each of the 2N lines. It is different from previous techniques because it actively exploits the fact that frequently all the elements in a line are quantized to zero, so the actual transform is irrelevant, and can be replaced with a zero matrix (null transform).

For a video segment (blocks, frames, etc.), the present invention can encode a set of line transforms using a graph-based signal representation. For example, the null transform and other general transforms (like the DCT) can be added to form a transform set. The transform set can be encoded, each transform in the transform set can be defined by using an index.

And, for each video segment the encoder selects an optimal transform set among transform sets, and the selected optimal transform set can be encoded and transmitted as side information.

### Advantageous Effects

The advantages of the present invention are that it maintains the flexibility to adaptively change transforms, helps reduce computational complexity, and also complements coding transform coefficients.

Furthermore, the present invention can provide enough variability in transforms to enable fast adaption to changing statistical properties in different video segments.

Furthermore, the present invention can reduce a computational complexity for coding a video signal, by using fixed separable transforms, and remarkably reduce an overhead in transmission of transform matrices and transform selection.

### DESCRIPTION OF DRAWINGS

FIGS. 1 and 2 illustrate schematic block diagrams of an encoder and decoder which process a video signal in accordance with embodiments to which the present invention is applied.

FIG. 3 represents a drawing illustrating a sample variance of residual pixel values in 8×8 transform blocks in accordance with embodiments to which the present invention is applied.

FIGS. 4A and 4B represent a row matrix and a column matrix for explaining a separable transform in accordance with embodiments to which the present invention is applied.

FIGS. 5A and 5B represent a row matrix and a column matrix for explaining a separable transform of which each of rows and columns has a different transform type in accordance with embodiments to which the present invention is applied.

FIG. 6 represents examples of a transform type being applicable for each rows and columns of a separable transform in accordance with embodiments to which the present invention is applied.

FIG. 7 illustrates schematic block diagrams of a transform unit which combines separable transform selection and zero signaling in accordance with an embodiment to which the present invention is applied.

FIGS. 8 and 9 are flowcharts illustrating a method of coding a video signal based on a separable transform selection and zero signaling in accordance with an embodiment to which the present invention is applied.

### BEST MODE

In accordance with an aspect of the present invention, there is provided a method of performing an adaptive video coding, comprising: determining transform subsets including a group index and linear transforms with dimensions M×M and N×N, wherein the linear transforms correspond to at least one of a null transform and predefined transforms; selecting an optimal transform subset for a transform unit from the determined transform subsets, wherein each of rows and columns of the transform unit corresponds to different linear transform; and encoding the optimal transform subset.

In accordance with another aspect of the present invention, the method further comprises calculating a transform coefficient of a residual block based on the optimal transform subset; quantizing the transform coefficient: and encoding a group index of the quantized transform coefficient.

In accordance with another aspect of the present invention, the optimal transform subset is selected for each of transform blocks.

In accordance with another aspect of the present invention, the transform blocks include variable-size blocks or non-square blocks.

In accordance with another aspect of the present invention, the method is repeatedly performed for a video segment.

In accordance with another aspect of the present invention, there is provided a method of adaptively decoding a video signal, comprising: receiving a video signal including a group index; extracting the group index from the video signal; and performing an inverse-transform of a residual block based on an optimal inverse-transform subset corresponding to the group index.

In accordance with another aspect of the present invention, there is provided an apparatus of performing an adaptive video coding, comprising: a transform unit configured to determine transform subsets including a group index and linear transforms with dimensions M×M and N×N, select an optimal transform subset for a transform unit from the determined transform subsets, and encode the optimal transform subset, wherein the linear transforms correspond to at least one of a null transform and predefined transforms, and wherein each of rows and columns of the transform unit corresponds to different linear transform.

In accordance with another aspect of the present invention, the apparatus further comprises a quantization unit configured to quantize a transform coefficient of a residual block, the transform coefficient being calculated based on the optimal transform subset; and an entropy encoding unit configured to encode a group index of the quantized transform coefficient.

In accordance with another aspect of the present invention, there is provided an apparatus of adaptively decoding a video signal, comprising: an inverse-transform unit configured to receive a video signal including a group index, extract the group index from the video signal, and perform an inverse-transform of a residual block based on an optimal inverse-transform subset corresponding to the group index.

### MODE FOR INVENTION

Hereinafter, exemplary elements and operations in accordance with embodiments of the present invention are described with reference to the accompanying drawings. It is however to be noted that the elements and operations of the present invention described with reference to the drawings are provided as only embodiments and the technical spirit and kernel configuration and operation of the present invention are not limited thereto.

Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be construed as being based on only the name of a term used in a corresponding description of this specification and that the present invention should be construed by checking even the meaning of a corresponding term.

Furthermore, terms used in this specification are common terms selected to describe the invention, but may be replaced with other terms for more appropriate analysis if such terms having similar meanings are present. For example, a signal, data, a sample, a picture, a frame, and a block may be properly replaced and interpreted in each coding process.

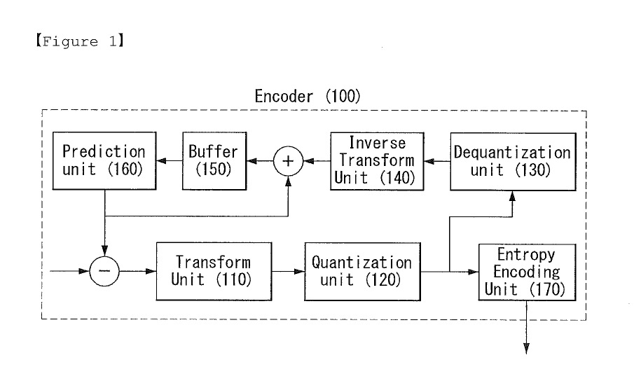

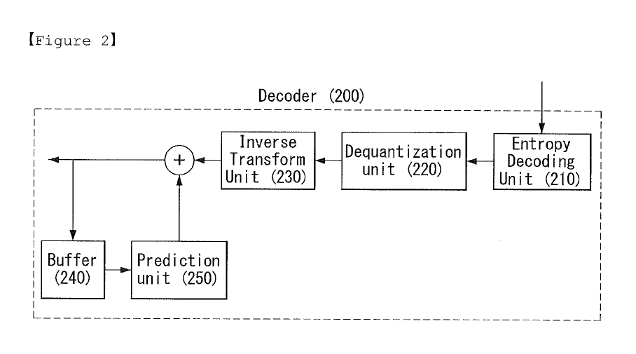

FIGS. 1 and 2 illustrate schematic block diagrams of an encoder and decoder which process a video signal in accordance with embodiments to which the present invention is applied.

The encoder 100 of FIG. 1 includes a transform unit 110, a quantization unit 120, a dequantization unit 130, an inverse transform unit 140, a buffer 150, a prediction unit 160, and an entropy encoding unit 170.

The encoder 100 receives a video signal and generates a prediction error by subtracting a predicted signal, output by the prediction unit 160, from the video signal.

The generated prediction error is transmitted to the transform unit 110. The transform unit 110 generates a transform coefficient by applying a transform scheme to the prediction error.

In this case, this invention is applicable to conventional forms of video coding that combine prediction and linear transforms.

In the previous video coding, the transforms were applied to pixels blocks that have a square type and with the same size (for example, 8×8 pixel block). However, the present invention is to extend the choices in pixels blocks that are transformed, and allowing for variable-size blocks and non-square blocks.

The present invention can consider a case which processes a residual block (i.e., original pixel values minus predicted pixel value) that are organized as an M×N matrix as equation 1.

$$R = [ \begin{matrix}{r}_{0 , 0} & {r}_{0 , 1} & {r}_{0 , 2} & … & {r}_{0 , N - 1} \\ {r}_{1 , 0} & {r}_{1 , 1} & {r}_{1 , 2} & … & {r}_{1 , N - 1} \\ {r}_{2 , 0} & {r}_{2 , 1} & {r}_{2 , 2} & … & {r}_{2 , N - 1} \\ ⋮ & ⋮ & ⋮ & ⋱ & ⋮ \\ {r}_{M - 1 , 0} & {r}_{M - 1 , 1} & {r}_{M - 1 , 2} & … & {r}_{M - 1 , N - 1}\end{matrix} ] \qquad [ Equation 1 ]$$

In the present invention, to reduce complexity when implementing a coding tool, the linear transform of matrix R in equation 1 can be defined in a fixed separable form as equation 2.

C=VRU [Equation 2]

where C represents a transform coefficient matrix, U and V are orthogonal transform matrices with dimensions M×M and N×N, respectively.

Before coding, the coefficient matrix may be quantized to produce matrix C_{q}. And the residual matrix reconstructed by the decoder may be computed using the inverse transform as equation 3.

R̅=V⁻¹C_{q}U⁻¹ [Equation 3]

Using this formulation, the transform coefficient matrix C can be computed with MN(M+N) operations (additions and multiplications). If U and V correspond to Discrete Cosine Transform (DCT), then C can be computed with (M log₂N+N log₂M) operations.

Referring to equation 3, in the video coding system, when M=N, U=V^{T} (i.e., U is the transpose matrix of V), C can be computed with 2N² or 2N log₂N operations.

The quantization unit 120 quantizes the transform coefficient and transmits the quantized coefficient to the entropy encoding unit 170.

The entropy encoding unit 170 performs entropy coding on the quantized coefficient and outputs an entropy-coded signal.

Meanwhile, the quantized signal output by the quantization unit 120 may be used to generate a prediction signal. For example, the dequantization unit 130 and the inverse transform unit 140 within the loop of the encoder 100 may perform dequantization and inverse transform on the quantized signal so that the quantized signal is reconstructed into a prediction error. A reconstructed signal may be generated by adding the reconstructed prediction error to a prediction signal output by the prediction unit 160.

The buffer 150 stores the reconstructed signal for the future reference of the prediction unit 160.

The prediction unit 160 generates a prediction signal using a previously reconstructed signal stored in the buffer 150.

The decoder 200 of FIG. 2 includes an entropy decoding unit 210, a dequantization unit 220, an inverse transform unit 230, a buffer 240, and a prediction unit 250.

The decoder 200 of FIG. 2 receives a signal output by the encoder 100 of FIG. 1.

The entropy decoding unit 210 performs entropy decoding on the received signal. The dequantization unit 220 obtains a transform coefficient from the entropy-decoded signal based on information related to a quantization step size. The inverse transform unit 230 obtains a prediction error by performing inverse transform on the transform coefficient. A reconstructed signal is generated by adding the obtained prediction error to a prediction signal output by the prediction unit 250.

The buffer 240 stores the reconstructed signal for the future reference of the prediction unit 250.

The prediction unit 250 generates a prediction signal using a previously reconstructed signal stored in the buffer 240.

The prediction method to which the present invention is applied will be used in both the encoder 100 and the decoder 200.

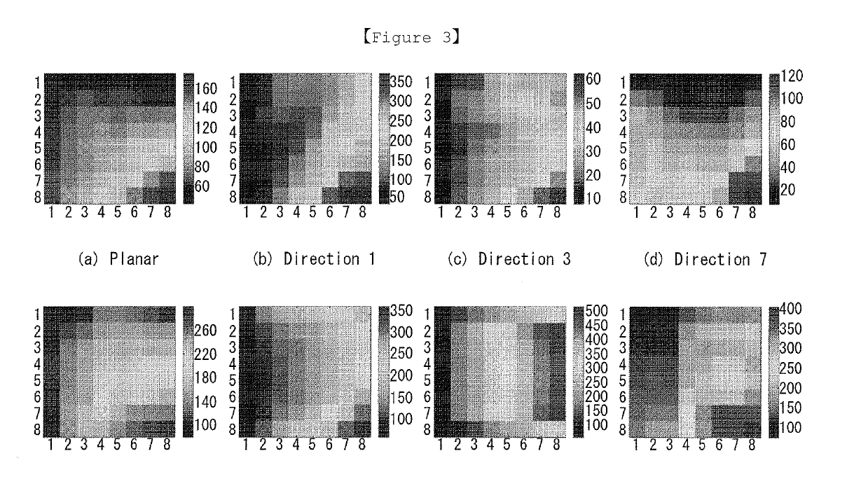

FIG. 3 represents a drawing illustrating a sample variance of residual pixel values in 8×8 transform blocks.

A main problem with the definition of a fixed and separable block linear transform as in equation 2 is that it is implicitly assuming that all residual blocks have the same isotropic statistical properties. However, in reality very different distributions can be observed, as shown in FIG. 3, depending on the type of video and also the prediction used for that block of pixels.

One method to exploit the distribution variations on the residual blocks, and obtain better compression, is to use different linear transforms for each block, i.e., have an adaptive scheme for the linear transforms.

For instance, if residual blocks are classified into a certain number of classes (residual block classification), the present invention can gather statistics for blocks in each class, and compute the Karhunen-Lo'eve Transform (KLT) for that class, and then apply to each block the transform corresponding to its classification.

Since the linear transform may be applied to the complete residual block, the present invention need to change notation to represent it in standard form. The present invention defines p and f as MN-dimensional vectors with row-major scan of matrices R and C, as equation 4.

p_{Ni+j}=r_{i,j}, f_{Ni+j}=c_{i,j}, i=0,1, . . . ,M−1, j=0,1, . . . ,N−1 [Equation 4]

Then the present invention can be represented as equation 5.

f=Tₖp, kε{0,1, . . . ,Φ−1} [Equation 5]

where Tₖ indicates the matrix selected from the available matrices for corresponding block.

In this case, it is easy to see that, since matrices Tₖ have dimension MN×MN, the present invention needs (MN)² operations to compute C from R using non-separable transforms (through Tₖ, f and p). Note that this computational complexity is significantly larger than that from the separable implementation of equation 2.

Therefore, the present invention can provide the below methods to practically implement adaptive transforms.

The first embodiment is to compute and select different transforms {Tₖ} using only information available to the encoder and decoder.

The second embodiment is to have the encoder compute and select different transforms {Tₖ}, and transmit to the decoder all transform matrices, and information about which transform to use for each block.

The third embodiment is to have a mixture of the two previous embodiments, where the encoder makes the decisions about the transforms, but the encoder and decoder use shared information to minimize the overhead needed for coding transform data.

The first embodiment is more suitable for data that has very consistent statistical properties.

The second embodiment is applicable only in the simplest cases, since the overhead of encoding full dense matrices can be very large compared to the low bit rate required for coding sets of sparse residual signals.

The combination of the two embodiments can potentially yield better compression, but it has to be carefully designed to maintain the bit rate used for adaption and side information under control. Thus, the present invention provides the new embodiment for overcoming the above problems.

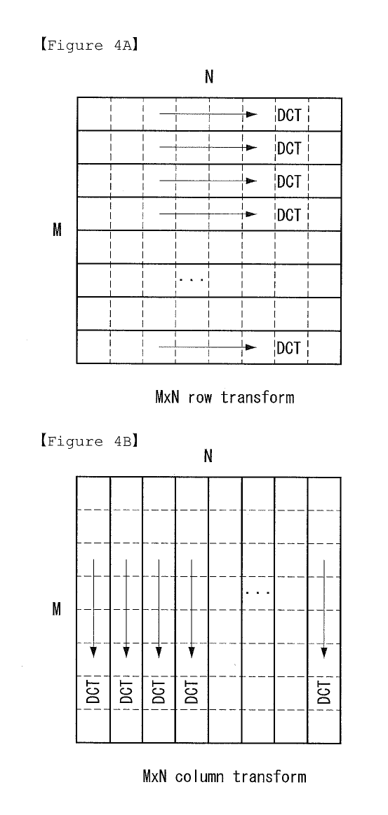

FIGS. 4A and 4B represent a row matrix and a column matrix for explaining a separable transform in accordance with embodiments to which the present invention is applied.

The present invention may be designed to solve the problems of the embodiments, as follows.

First, it is desirable to change the linear transform applied to each block to match its statistical properties.

Second, it is to avoid the high computational complexity of non-separable transforms.

Third, the overhead used for transmitting the transform matrix data and selecting a transform has to be relatively small to enable overall coding gains.

Accordingly, in an embodiment of the present invention, the separable transforms can be defined as follows.

FIG. 4A represents a row transform applicable to M×N block, and FIG. 4B represents a column transform applicable to M×N block.

It can be checked that the same transform matrix (like a DCT) is applied for each rows in FIG. 4A, and the same transform matrix (like a DCT) is applied for each columns in FIG. 4B.

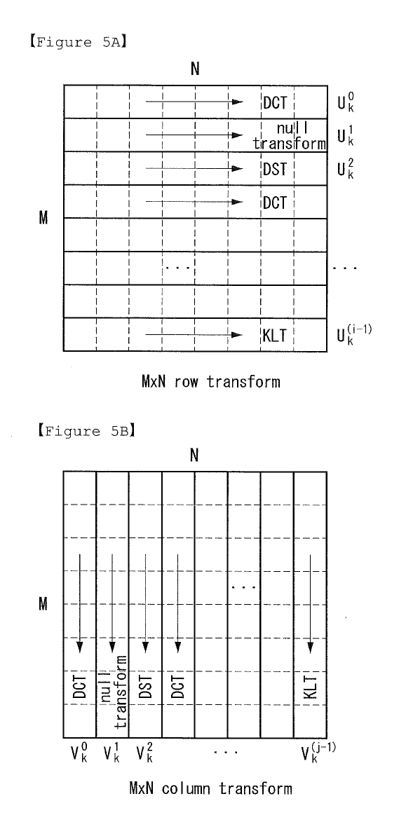

FIGS. 5A and 5B represent a row matrix and a column matrix for explaining a separable transform of which each of rows and columns has a different transform type in accordance with embodiments to which the present invention is applied.

Instead of using MN×MN matrices Tₖ, the present invention can use M×M and N×N orthogonal matrices as equations 6 and 7.

Uₖ⁽ⁱ⁾, i=0,1, . . . ,M−1, k=0,1, . . . ,Φ−1 [Equation 6]

Vₖ^{(j)}, j=0,1, . . . ,N−1, k=0,1, . . . ,Φ−1 [Equation 7]

Sets of (M+N) of those matrices can be sequentially used to transform the rows and columns of R to obtain C. The whole process, at the encoder, can be defined by the following sequence of operations as equations 8 to 12.

xⱼ^{(i)=r}ᵢⱼ [Equation 8]

y⁽ⁱ⁾=Uₖ⁽ⁱ⁾x⁽ⁱ⁾ [Equation 9]

pᵢ^{(j)}=yⱼ⁽ⁱ⁾ [Equation 10]

q^{(j)}=Vₖ^{(j)}p^{(j)} [Equation 11]

c_{i,j}=qᵢ^{(j)} [Equation 12]

For example, the equation 8 represents a process for obtaining vectors from matrix rows, the equation 9 represents a process for performing a horizontal transform, the equation 10 represents a process for obtaining vectors from transformed columns, the equation 11 represents a process for performing a vertical transform, and the equation 12 represents a process for obtaining matrix columns from vectors.

According to a reverse order of above-mentioned processes, the decoder can perform an inverse transform using the inverse matrices [Uₖ⁽ⁱ⁾]⁻¹ and [Vₖ^{(j)}]⁻¹. Note that the maximum number of operations for the inverse transform is MN(M+N).

An important property of transforms for residual signals, which is exploited by this invention, is the fact that the matrix of quantized transform coefficients C_{q} can be composed of many zeros. Or, it is common to have blocks with all elements equal to zero. Thus, the present invention proposes more general methods.

To exploit the sparse nature of C_{q}, the present invention can include the zero matrix (i.e. null transform) among the possible values of matrices [Uₖ⁽ⁱ⁾] and [Vₖ^{(j)}].

The null transform is not used as real transforms, but instead is used to signal to the decoder that the corresponding signal should be treated as zero, and thus is not affected by any linear transform.

Accordingly, the present invention can define a separable transform of which each rows and columns has a different transform type.

FIG. 5A represents row transforms applicable to M×N block, and FIG. 5B represents column transforms applicable to M×N block.

It can be checked that a different transform matrix is applied for each rows in FIG. 5A, and a different transform matrix is applied for each columns in FIG. 5B. For example, as shown in FIG. 5A, a DCT is applied to a first row, a null transform is applied to a second row, a DST is applied to a third row, a DCT is applied to a fourth row, and a KLT is applied to i-th row. And, as shown in FIG. 5B, a DCT is applied to a first column, a null transform is applied to a second column, a DST is applied to a third column, a DCT is applied to a fourth column, and a KLT is applied to i-th column.

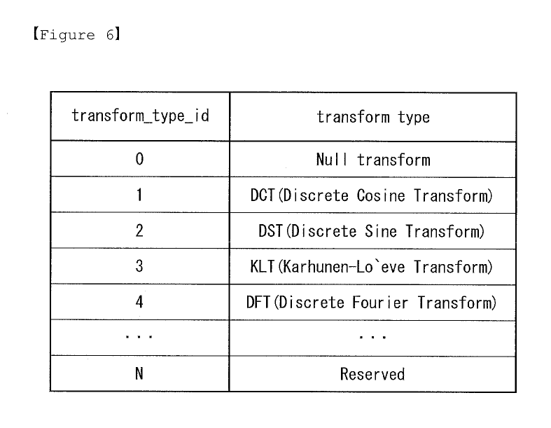

FIG. 6 represents examples of a transform type being applicable for each rows and columns of a separable transform in accordance with embodiments to which the present invention is applied.

The present invention defines a separable transform of which each rows and columns has a different transform type, where the different transform type may be defined by using a transform type identifier.

Furthermore, the different transform type includes at least one of a null transform and predefined transforms. For example, the predefined transforms include DCT (Discrete Cosine Transform), ADST (Asymmetric Discrete Sine Transform), DST (Discrete Sine Transform), DFT (Discrete Fourier Transform), and KLT (Karhunen-Lo'eve Transform).

Referring to FIG. 6, the present invention defines “transform_type_id” for identifying a transform type to be applied to each rows and columns. For example, if transform_type_id=0, the transform type indicates a null transform, if transform_type_id=1, the transform type indicates a DCT, if transform_type_id=2, the transform type indicates a DST, if transform_type_id=3, the transform type indicates a KLT, and if transform_type_id=4, the transform type indicates a DFT. Furthermore, the present invention can define a reserved area for adding another transform types.

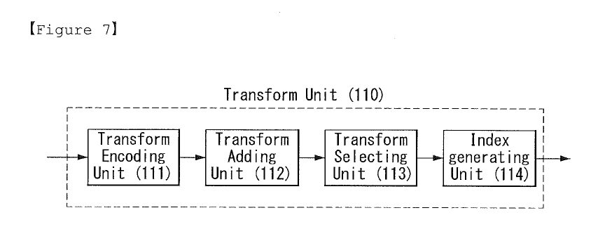

FIG. 7 illustrates schematic block diagrams of a transform unit which combines separable transform selection and zero signaling in accordance with an embodiment to which the present invention is applied.

Referring to FIG. 7, the transform unit (110) to which the present invention is applied includes transform encoding unit (111), transform adding unit (112), transform selecting unit (113) and index generating unit (114).

The present invention provides a progressive coding scheme which is repeated for a video segment (blocks, frames, etc.).

The transform encoding unit (111) may encode a set of orthogonal line transforms, of sizes M×M and N×N (or only one size if M=N), for instance, based on graph Laplacians.

The transform adding unit (112) may add the null transform and predefined transforms for formation of 2 transform set as equation 13.

[symbol]

={G₀,G₁, . . . ,G_{Ω-1}}, [symbol] ={H₀,H₁, . . . ,H_{Ω-1}} [Equation 13]

In the equation 13, G represents a transform set for rows, and H represents a transform set for columns. In this case, the transform set G for rows includes Ω transforms {G₀, G₁, . . . , G_{Ω-1}}, the transform set H for columns includes Ω transforms {H₀, H₁, . . . , H_{Ω-1}}, and elements of the Ω transforms correspond to different transform matrices. For example, G₀ represents a DCT, G₁ represents a DST, G_{Ω-1} represents a KLT, H₀ represents a ADST, H₁ represents a DCT, and H_{Ω-1} represents a KLT.

Meanwhile, the transform set G for rows and the transform set H for columns, can be pre-stored in at least one of an encoder and a decoder, or can be derived from other coding information.

In another embodiment, the transform set G for rows and the transform set H for columns can be encoded and transmitted to a decoder. Or, only index information corresponding to a transform table stored in at least one of an encoder and a decoder can be transmitted to the decoder, and the decoder can generate the transform set G for rows and the transform set H for columns based on index information.

Furthermore, the present invention can define a transform set by encoding an index array for transmitted transforms. For example, the index array can be represented by an index set, as equation 14.

[symbol]

ₖ=(μ_{i,k}), i=0,1, . . . ,M−1, k=0,1, . . . ,Φ−1

[symbol]

ₖ=(ν_{j,k}), j=0,1, . . . ,N−1, k=0,1, . . . ,Φ−1 [Equation 14]

In equation 14, Mₖ indicates an index set corresponding to row transforms, and Nₖ indicates an index set corresponding to column transforms. And, μ_{i,k}ε{0, 1, . . . , Ω−1}, ν_{j,k}ε{0, 1, . . . , Ω−1}, μ_{i,k} indicates an index corresponding to each of row transforms, ν_{j,k} indicates an index corresponding to each of column transforms, and k indicates a group index.

The relationship between index sets for each of rows and columns and corresponding transform sets can be defined as equation 15.

Uₖ⁽ⁱ⁾=G_{μi,k}, Vₖ^{(j)}=H_{νj,k} [Equation 15]

In equation 15, Uₖ⁽ⁱ⁾ and Vₖ^{(j)} indicate a row transform and a column transform, respectively, and G_{μi,k} and H_{νj,k} indicate a row transform and a column transform corresponding to indexes μ_{i,k} and ν_{j,k}, respectively.

For example, for a group index k=0, a set of M row transforms U₀⁰, U₀¹, . . . , U₀^{M-1} can be defined, and a set of N column transforms V₀⁰, V₀¹, . . . , V₀^{N-1} can be defined.

In this case, each of the M row transforms corresponds to any one within a predefined set of row transforms. Specifically, each of the M row transforms corresponds to any one within Ω transforms {G₀, G₁, . . . , G_{Ω-1}} included in row transform set G of the equation 13.

Furthermore, each of the N column transforms corresponds to any one within a predefined set of column transforms. Specifically, each of the M column transforms corresponds to any one within Q transforms {H₀, H₁, . . . , H_{Ω-1}} included in column transform set H of the equation 13.

For each video block, the transform selecting unit (113) may select an optimal row/column transform set among the Ω transmitted row/column transform sets and the index generating unit (114) may encode a group index k corresponding to the optimal row/column transform set. In this case, the optimal row/column transform set can be selected based on a RD (Rate-Distortion) Cost function.

Meanwhile, differences between the transmitted pattern and the actual pattern (e.g., with more uses of the null transform) can be coded just after encoding the group index k.

And, the transform C for a residual block R can be computed by using a sequence of operations in equation 8.

Then, the quantization unit (120) can quantize the transform C to obtain C_{q} and encode integer-quantized indexes of C_{q}.

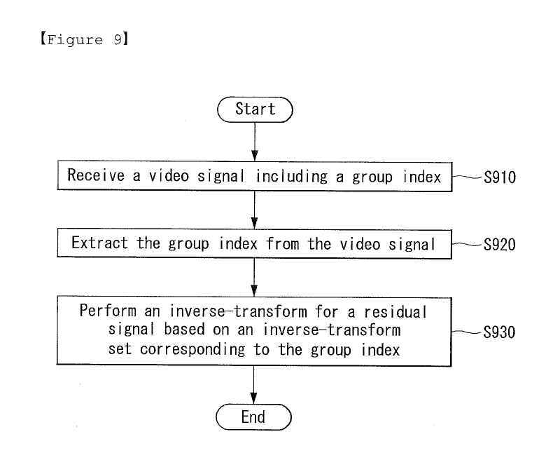

The decoder may be defined by simply reversing the encoder operations, except the search for an optimal group index k. The decoding process will be explained in detail in FIG. 9.

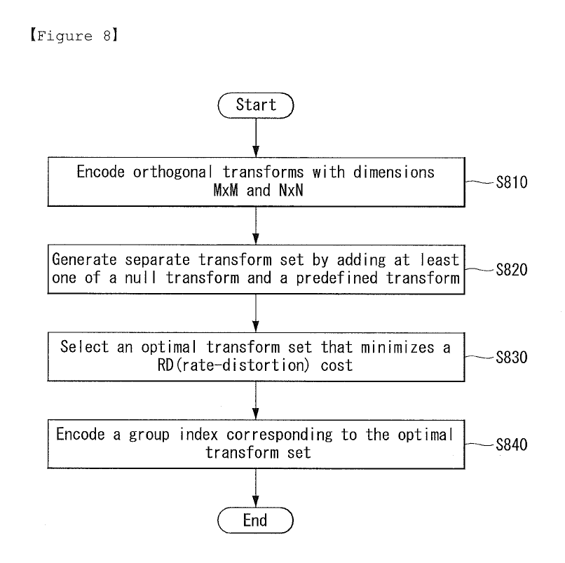

FIGS. 8 and 9 are flowcharts illustrating a method of coding a video signal based on a combination of separable transform selection and zero signaling in accordance with an embodiment to which the present invention is applied.

In an embodiment of the present invention, a method of performing an adaptive video encoding with combined separable transform selection and zero signaling is provided.

Referring to FIG. 8, the encoder can encode orthogonal transforms with dimensions M×M and N×N (S810). In this case, the orthogonal transforms with dimensions M×M and N×N may be based on graph laplacians.

The encoder can generate separately an orthogonal transform set by adding at least one of a null transform and a predefined transform (S820). In this case, the null transform and the predefined transform may be defined by using a transform type identifier (“transform_type_id”), and the encoder can enhance transmission efficiency by encoding and transmitting the transform type identifier.

The encoder can select an optimal transform set that minimizes a RD (rate-distortion) cost (S830). In this case, the optimal transform set can be selected for each of transform blocks. And, the transform blocks can include variable-size blocks or non-square blocks.

The encoder can encode a group index corresponding to the optimal transform (S840). For example, the group index may be defined as equation 14. And, if the orthogonal transforms have a size of M×M and N×N, (M+N) index arrays of corresponding group index are encoded.

The above process may be repeatedly performed for a video segment.

In another embodiment of the present invention, a method of performing an adaptive video decoding with separable transform selection and zero signaling is provided.

Referring to FIG. 9, the decoder can receive a video signal including a group index (S910), and extract the group index from the video signal (S920). The decoder can obtain an inverse-transform set corresponding to the group index. For example, the inverse-transform set corresponds to an optimal transform set selected from an encoder. The inverse-transform set can be pre-stored in at least one of an encoder and a decoder, where the inverse-transform set can be derived from a place stored in the decoder by using the group index.

Meanwhile, the decoder entropy-decodes and de-quantizes a received video signal to obtain an de-quantized transform coefficient. In this case, the de-quantized transform coefficient means a transform coefficient obtained based on an optimal transform set selected from the encoder.

Then, the decoder performs an inverse-transform for a residual signal based on the inverse-transform set (S930). In this case, the residual signal means the de-quantized transform coefficient. And, the inverse-transform set corresponds to any one of separate transform sets to which a null transform and a predefined transform are added.

The inverse-transformed residual signal is added to a prediction signal, and thereby a reconstruction signal can be generated.

As described above, the embodiments explained in the present invention may be implemented and performed on a processor, a micro processor, a controller or a chip. For example, functional units explained in FIGS. 1, 2, 7 may be implemented and performed on a computer, a processor, a micro processor, a controller or a chip.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional (3D) video apparatus, a teleconference video apparatus, and a medical video apparatus and may be used to code video signals and data signals.

Furthermore, the decoding/encoding method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves (e.g., transmission through the Internet). Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1. A method of performing an adaptive video coding, comprising:
determining transform subsets including a group index and linear transforms with dimensions M×M and N×N, wherein the linear transforms correspond to at least one of a null transform and predefined transforms;
selecting an optimal transform subset for a transform unit from the determined transform subsets, wherein each of rows and columns of the transform unit corresponds to different linear transform; and
encoding the optimal transform subset.

2. The method of claim 1, further comprising:
calculating a transform coefficient of a residual block based on the optimal transform subset;
quantizing the transform coefficient: and
encoding a group index of the quantized transform coefficient.

3. The method of claim 1,
wherein the optimal transform subset is selected for each of transform blocks.

4. The method of claim 3,
wherein the transform blocks include variable-size blocks or non-square blocks.

5. The method of claim 1,
wherein the method is repeatedly performed for a video segment.

6. A method of adaptively decoding a video signal, comprising:
receiving a video signal including a group index;
extracting the group index from the video signal; and
performing an inverse-transform of a residual block based on an optimal inverse-transform subset corresponding to the group index.

7. The method of claim 6,
wherein the optimal inverse-transform subset corresponds to each of transform blocks.

8. The method of claim 7,
wherein the transform blocks include variable-size blocks or non-square blocks.

9. An apparatus of performing an adaptive video coding, comprising:
a transform unit configured to
determine transform subsets including a group index and linear transforms with dimensions M×M and N×N,
select an optimal transform subset for a transform unit from the determined transform subsets, and
encode the optimal transform subset,
wherein the linear transforms correspond to at least one of a null transform and predefined transforms, and
wherein each of rows and columns of the transform unit corresponds to different linear transform.

10. The apparatus of claim 1, further comprising:
a quantization unit configured to quantize a transform coefficient of a residual block, the transform coefficient being calculated based on the optimal transform subset; and
an entropy encoding unit configured to encode a group index of the quantized transform coefficient.

11. The apparatus of claim 9,
wherein the optimal transform subset is selected for each of transform blocks.

12. The apparatus of claim 11,
wherein the transform blocks include variable-size blocks or non-square blocks.

13. An apparatus of adaptively decoding a video signal, comprising:
an inverse-transform unit configured to
receive a video signal including a group index,
extract the group index from the video signal, and
perform an inverse-transform of a residual block based on an optimal inverse-transform subset corresponding to the group index.

14. The apparatus of claim 13,
wherein the optimal inverse-transform subset corresponds to each of transform blocks.

15. The apparatus of claim 14,
wherein the transform blocks include variable-size blocks or non-square blocks.
